(19) United States
(12) Patent Application Publication
(10) Pub. No.: US 2019/0161045 A1
(43) Pub. Date: May 30, 2019

(54) AIRBAG ASSEMBLY CONFIGURED TO DEPLOY FROM A SIDE WALL OF A VEHICLE TO RESIST UPWARD MOTION OF THE LEG OF AN OCCUPANT, AND A SYSTEM AND METHOD FOR CONTROLLING THE AIRBAG ASSEMBLY

(71) Applicant: GM Global Technology Operations LLC, Detroit, MI (US)

(72) Inventors: Scott D. THOMAS, Novi, MI (US); Brennon L. WHITE, Novi, MI (US)

(73) Assignee: GM Global Technology Operations LLC, Detroit, MI (US)

(21) Appl. No.: 15/825,800

(22) Filed: Nov. 29, 2017

(51) Int. Cl. B60R 21/21; B60R 21/2338; B60R 21/239; B60R 21/276; B60R 21/0136

(52) U.S. Cl. CPC B60R 21/21; B60R 21/2338; B60R 21/239; B60R 21/233; B60R 21/0136; B60R 2021/23386; B60R 21/276

(57) ABSTRACT

An airbag assembly according to the present disclosure includes an elongated cushion and a restraint. The elongated cushion is configured to deploy from an interior side wall of a vehicle into a passenger compartment of the vehicle to resist upward motion of a leg of an occupant of the vehicle. The restraint is configured to prevent the elongated cushion from rotating upward and toward the side wall when the leg of the occupant contacts an underside surface of the elongated cushion.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to airbag assemblies configured to deploy from a side wall of a vehicle to resist upward motion of the leg of an occupant, and systems and methods for controlling such airbag assemblies.

Airbag assemblies typically include an airbag cushion and an inflator that is operable to inflate the airbag cushion. The inflator includes a tube having a closed end containing a gas source and an open end opposite the closed end and positioned within the airbag cushion. The gas source typically includes an electric igniter and at least one of an explosive charge such as solid propellant and a stored gas charge stored under high pressure. The electric igniter ignites the solid propellant and/or releases the stored gas in response to an electronic control signal, which produces a gas that inflates the airbag cushion.

Airbag assemblies are typically mounted in a dashboard of a vehicle, in a seat of a vehicle, and/or in a steering wheel of a vehicle. However, some airbag assemblies are mounted to a sidewall of a vehicle and deploy in a laterally inward or cross-car direction relative to the sidewall. Such airbag assemblies are commonly referred to as side-deploying airbags.

### SUMMARY

An airbag assembly according to the present disclosure includes an elongated cushion and a restraint. The elongated cushion is configured to deploy from an interior side wall of a vehicle into a passenger compartment of the vehicle to resist upward motion of a leg of an occupant of the vehicle. The restraint is configured to prevent the elongated cushion from rotating upward and toward the side wall when the leg of the occupant contacts an underside surface of the elongated cushion.

In one example, the restraint includes a tether configured to wrap around a top surface of the elongated cushion when the elongated cushion is deployed and having opposite ends configured to be fixed relative to the side wall.

In one example, the airbag assembly further includes a mounting plate to which the elongated cushion is attached, wherein the opposite ends of the tether are fixed to the mounting plate.

In one example, the opposite ends of the tether are configured to be fixed directly to the side wall of the vehicle.

In one example, the tether is attached to at least one of the top surface of the elongated cushion and a side surface of the elongated cushion.

In one example, the airbag assembly further includes a housing and a door. The housing is configured to be disposed within and attached to the side wall and to contain the elongated cushion before the elongated cushion is deployed. The door is configured to conceal the elongated cushion from view when the elongated cushion is contained within the housing.

In one example, the airbag assembly further includes a hinge attaching the door to the housing and allowing the door to pivot when the elongated cushion is deployed. In this example, the restraint includes the door and at least one tether having a first end configured to be fixed relative to the side wall and a second end opposite of the first end and attached to the door to limit an amount by which the door pivots upwards when the elongated cushion is deployed.

In one example, the restraint includes at least one tether disposed within the elongated cushion and having a first end configured to be fixed relative to the side wall and a second end opposite of the first end and attached to an upper inner surface of the elongated cushion.

In one example, the elongated cushion has a first end configured to be fixed relative to the side wall and a second end opposite of the first end, and the restraint includes an inflated foot disposed adjacent to the first end of the elongated cushion and projecting from a top surface of the elongated cushion.

In one example, the elongated cushion includes at least one tubular chamber having a longitudinal axis extending in a lateral direction of the vehicle.

In one example, the at least one tubular chamber includes multiple tubular chambers in fluid communication with one another.

In one example, the airbag assembly further includes multiple tethers disposed within the elongated cushion and defining a boundary between the tubular chambers.

In one example, the airbag assembly further includes at least one seam joining portions of the elongated cushion to one another and defining a boundary between the tubular chambers.

An airbag system according to the present disclosure includes a first elongated cushion and an interlocking device. The first elongated cushion is configured to deploy from one of a first interior side wall of a vehicle and a center structure of the vehicle into a passenger compartment of the vehicle, the first elongated cushion having a first end mounted to the one of the first interior side wall and the center structure and a second end opposite of the first end. The interlocking device is configured to interlock with the second end of the first elongated cushion to prevent the first elongated cushion from moving out of a path of a leg of an occupant of the vehicle when the leg contacts the first elongated cushion.

In one example, the interlocking device includes the other one of the first interior side wall and the center structure.

In one example, the interlocking device includes a second elongated cushion configured to deploy from a second interior side wall of the vehicle that is opposite of the first interior side wall.

A control system according to the present disclosure includes an inflator control module and a vent control module. The inflator control module is configured to control an inflator to deploy an airbag cushion from an interior side wall of a vehicle into a space disposed in front of a seat of the vehicle relative to a direction in which the seat is facing. The vent control module is configured to control a vent to deflate the airbag cushion after the airbag cushion is deployed.

In one example, the inflator control module is configured to control the inflator to deploy the airbag cushion when an occupant is present in the seat and the vehicle is involved in an impact having a magnitude that is greater than a predetermined value.

In one example, the vent control module is configured to open the vent when a predetermined amount of time has elapsed after the vehicle is involved in an impact.

In one example, the airbag cushion is mounted to a door of the vehicle, the interior side wall is part of the door, and the vent control module is configured to open the vent when the door is opened after the vehicle is involved in an impact.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side view of an passenger compartment in a vehicle including examples of an airbag assembly and an airbag control module according to the present disclosure;

FIGS. 2 and 3 are side views of other example airbag assemblies according to the present disclosure;

FIGS. 4-6 are perspective views of other example airbag assemblies according to the present disclosure;

FIG. 7 is a perspective view of a portion of another example airbag assembly according to the present disclosure;

FIG. 8 is a planar view of an example tether for use in an airbag assembly according to the present disclosure;

FIGS. 9-11 are perspective views of other example airbag assemblies according to the present disclosure;

FIG. 12 is an exploded perspective view of the example airbag assembly of FIG. 11 with an airbag cushion of the example airbag assembly shown in a flat state before portions of the airbag cushion are sewn together to form inflated chambers;

FIG. 13 is a perspective view of another example airbag assembly according to the present disclosure;

FIG. 14 is an exploded perspective view of the example airbag assembly of FIG. 13 with an airbag cushion of the example airbag assembly shown in a flat state before portions of the airbag cushion are sewn together to form inflated chambers;

FIGS. 15 and 16 are cross-sectional views of an example airbag cushion according to the present disclosure including internal tethers defining boundaries between inflated chambers of the example airbag cushion;

FIGS. 17 and 18 are cross-sectional views of an example airbag cushion according to the present disclosure including internal tethers joining an upper interior surface of the example airbag cushion to a mounting structure of a vehicle;

FIGS. 19 and 20 are perspective views of an example airbag cushion according to the present disclosure deploying from a side wall of a vehicle and interlocking with a center console of the vehicle;

FIGS. 21 and 22 are perspective views of an example airbag cushion according to the present disclosure deploying from a center console of a vehicle and interlocking with a side wall of the vehicle;

FIG. 23 is a perspective view of two airbag cushions according to the present disclosure interlocking with one another;

FIG. 24 is a cross-sectional view of a pyrotechnic vent according to the present disclosure;

FIGS. 25 and 26 are top views of a portion of an example airbag assembly according to the present disclosure including a vent that is actuated by a tether;

FIG. 27 is an end view of another example airbag assembly according to the present disclosure shown in an uninflated state;

FIG. 28 is a perspective view of another example airbag assembly according to the present disclosure shown in an uninflated state;

FIG. 29 is a cross-sectional view of another example airbag assembly according to the present disclosure;

FIG. 30 is a functional block diagram of an example airbag control system according to the present disclosure; and

FIG. 31 is a flowchart illustrating an example airbag control method according to the present disclosure.

In the drawings, reference numbers may be reused to identify similar and/or identical elements.

### DETAILED DESCRIPTION

When an occupant is sitting in a seat of a vehicle that is involved in an impact and the occupant is wearing a seatbelt, the torso of the occupant is restrained in the seat by the seatbelt. However, the lower halves of the legs of the occupant may rotate upward due to an abrupt deceleration of the vehicle caused by an impact to a portion of the vehicle in front of the occupant. In most current vehicles, all of the occupants face in the same direction, and the vehicle include structure (e.g., instrument panel, seat in front of occupant) that the lower halves of the legs of the occupant contact when a portion of the vehicle in front of the occupant is impacted. Thus, the leg contact structure of the vehicle limits the amount by which the lower halves of the legs of the occupant rotate when the vehicle is involved in an impact, which prevents the knees of the occupant from hyperextending.

In future vehicle seating arrangements, there may not be a leg contact structure in front of the legs of the occupant. For example, in an autonomous vehicle, it may not be necessary for the occupants seated in the front row to face forward at all times. Thus, one row of seats in an autonomous vehicle may face another row of seats in the autonomous vehicle.

An airbag assembly according to the present disclosure limits the amount by which the lower halves of the legs of an occupant rotate upward when a portion of a vehicle in front of an occupant is impacted and the vehicle does not have a leg contact structure for an occupant. The airbag assembly includes an elongated airbag cushion that deploys from an interior side wall of the vehicle into a passenger compartment of the vehicle in a space that is disposed above the legs of the occupant. Thus, the lower halves of the occupant's legs contact the airbag cushion when the lower leg halves rotate upward, which prevents the occupant's knees from hyperextending. The interior side wall from which the airbag cushion deploys may be part of a body structure, a door, or a center structure of the vehicle such as a center console.

In some examples, the airbag assembly includes a restraint, such as a tether or an inflated foot, which prevents the airbag cushion from moving out of the travel path of the occupant's lower legs when the lower legs contact the airbag cushion. The tether may be wrapped around a top surface of the airbag cushion and have opposite ends that are fixed relative to the interior side wall from which the airbag cushion deploys. The inflated foot may project from the top surface of the airbag cushion and have the shape of a right triangle, with one leg of the triangle contacting the interior side wall as the airbag cushion rotates upward and toward the interior side wall. In this regard, the inflated foot may act as a stop for the airbag cushion.

An airbag system according to the present disclosure includes an airbag assembly as described above and an interlocking device configured to interlock with a free end of the airbag cushion opposite of the end of the airbag cushion mounted in the interior side wall. Similar to the restraint, the interlocking device prevents the airbag cushion from moving out of the travel path of the occupant's lower legs when the lower legs contact the airbag cushion. In one example, the interlocking device is a center structure of the vehicle such as a center console having a receptacle into which the free end of the airbag cushion extends when the airbag cushion deploys. In another example, the interlocking device is another airbag cushion, the airbag cushions are positioned opposite of one another in a lateral (e.g., side-to-side) direction of the vehicle, and the free ends of the airbag cushions are configured to interlock with each other.

An airbag control system and method according to the present disclosure deploys an airbag cushion in an airbag assembly as described above when a vehicle is involved in an impact. In one example, the control system and method deploys the airbag cushion when an occupant is present in a seat associated with the airbag cushion and the magnitude of the impact is greater than a predetermined value. The control system and method may also open a vent on the airbag cushion after the impact to deflate the airbag cushion to make it easier for an occupant to exit the vehicle. In one example, the control system and method opens the vent on the airbag cushion when a predetermined amount of time has elapsed after the impact. In another example, the airbag assembly is mounted in a door of the vehicle, and the control system and method opens the vent on the airbag cushion when a door in which the airbag assembly is mounted is opened.

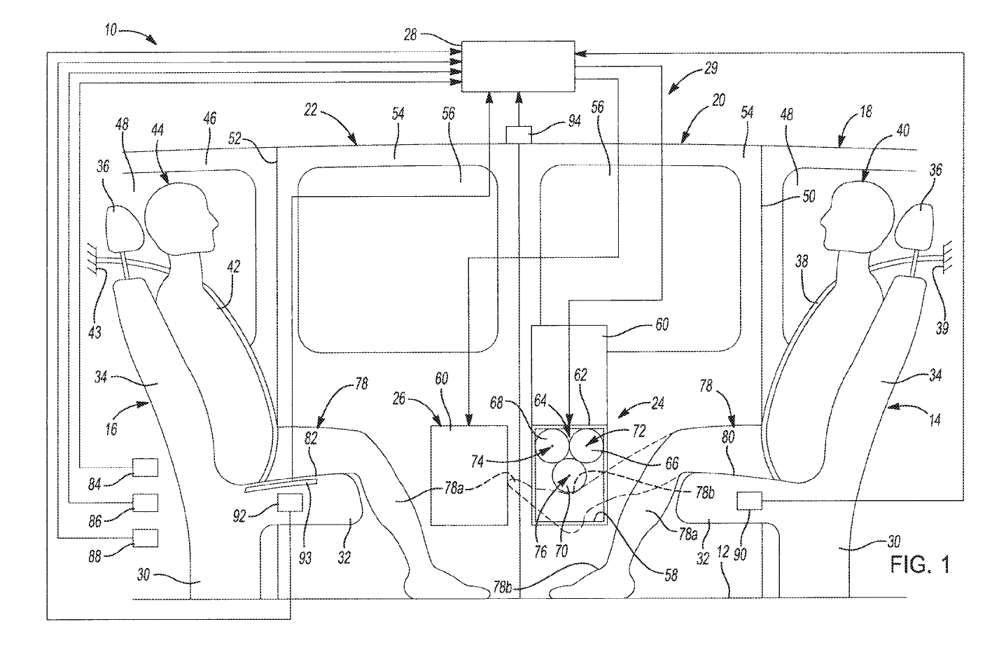

Referring now to FIG. 1, an example vehicle 10 according to the present disclosure includes a floor panel 12, a first seat 14, a second seat 16, a body side wall 18, a first door 20, a second door 22, a first airbag assembly 24, a second airbag assembly 26, and an airbag control module 28. The floor panel 12, the body side wall 18, the first door 20, and the second door 22 at least partially form a passenger compartment 29 of the vehicle 10. Although the airbag control module 28 is shown above the passenger compartment 29, the airbag control module 28 may be mounted to a lower structure of the vehicle 10. The floor panel 12 may be made from plastic and/or metal. The first and second seats 14 and 16 face one another. To this end, the vehicle 10 may be an autonomous vehicle. Each of the first and second seats 14 and 16 includes a base 30, a bottom 32, a back 34, and a head restraint 36. A first seatbelt 38 is fixed to the body side wall 18 or other body or seat structure at a location 39 and extends around a first occupant 40 to restrain the first occupant 40 in the first seat 14. Similarly, a second seatbelt 42 is fixed to the body side wall 18 or other body or seat structure at a location 43 and extends around a second occupant 44 to restrain the second occupant 44 in the second seat 16.

The body side wall 18 includes an inner panel 46, an outer panel (not shown) opposite of the inner panel 46, and a pair of windows 48 covering openings that extend through the inner panel 46 and the outer panel. The inner panel 46 may be made from plastic, and the outer panel may be made from metal. The first and second doors 20 and 22 cover another opening that extends through the inner panel 46 and the outer panel, and the windows 48 are disposed on opposite sides of that opening in a longitudinal (i.e., fore-aft) direction of the vehicle 10.

The first door 20 is attached to the vehicle body side wall 18 using a first door linkage 50, and the second door 22 is attached to the vehicle body side wall 18 using a second door linkage 52. Although each of the first and second door linkages 50 and 52 are represented using a single line in FIG. 1, each of the door linkages 50, 52 may including a plurality of linkages, rollers, guides, or other components that allow the first and second doors 20 and 22 to open and close by sliding or pivoting relative to the vehicle body side wall 18. Each of the first and second doors 20 and 22 includes an inner panel 54, an outer panel (not shown) opposite of the inner panel 54, and a window 56 covering an opening that extends through the inner panel 54 and the door outer panel. The inner panels 54 may be made from plastic, and the door outer panels may be made from metal. The inner panels 46 and 54 of the body side wall 18 and the doors 20, 22 may be referred to as interior side walls.

The first airbag assembly 24 is mounted within the first door 20, and the second airbag assembly 26 is mounted within the second door 22. Each of the first and second airbag assemblies 24 and 26 includes a housing 58, a door 60, a hinge 62 connecting the door 60 to the housing 58, and an elongated airbag cushion 64. The housing 58 may be made from plastic, a composite, a polymer, a combination of plastic and polymer such as thermoplastic olefin (TPO), aluminum, or metal, and the door 60 may be made from plastic, a polymer, or a combination thereof such as thermoplastic olefin (TPO). The housing 58 contains the airbag cushion 64 before the airbag cushion 64 is deployed, and the door 60 conceals the airbag cushion 64 from view when the airbag cushion 64 is contained within the housing 58. The housing 58 of the first airbag assembly 24 is attached to the inner panel 54 of the first door 20, the outer panel of the first door 20, and/or an intermediate structure of the first door 20 disposed between the inner panel 54 of the first door 20 and the outer panel of the first door 20. Similarly, the housing 58 of the second airbag assembly 26 is attached to the inner panel 54 of the second door 22, the outer panel of the second door 22, and/or an intermediate structure of the second door 22 disposed between the inner panel 54 of the second door 22 and the outer panel of the second door 22.

The airbag cushions 64 of the first and second airbag assemblies 24 and 26 deploy from the inner panels 54 of the first and second doors 20 and 22 into the passenger compartment 29 in a lateral (i.e., side-to-side) direction of the vehicle 10. The airbag cushion 64 of the first airbag assembly 24 deploys from the inner panel 54 of the first door 20 into a space disposed in front of the first seat 14 relative to the direction in which the first seat 14 is facing. Similarly, the airbag cushion 64 of the second airbag assembly 26 deploys from the inner panel 54 of the second door 22 into a space disposed in front of the second seat 16 relative to the direction in which the second seat 16 is facing.

Each airbag cushion 64 pivots the door 60 about the hinge 62 from a closed position to an open position when the airbag cushion 64 is deployed. The door 60 is flush with the inner panel with the door 60 is in the closed position. The door 60 rotates upward and toward the inner panel 54 as the door 60 pivots from the closed position to the open position. In FIG. 1, the airbag cushion 64 of the first airbag assembly 24 is deployed and the door 60 of the first airbag assembly 24 is in the open position. In contrast, the airbag cushion 64 of the second airbag assembly 26 has not yet been deployed and the door 60 of the second airbag assembly 26 is in the closed position.

The door 60 may be mounted in the vehicle 10 at locations and using hinge configurations other than those shown in FIG. 1. For example, the door 60 may have one or more hinges on one of its vertical edges and/or the door 60 may be mounted near the center of the vehicle 10. The door 60 may also have hinges on more than one of its edges with a tear seam pattern on the door 60 similar to various configurations used on a driver airbag assembly mounted in a steering wheel.

Each airbag cushion 64 includes a first inflated chamber 66, a second inflated chamber 68, and a third inflated chamber 70. Each of the first, second, and third inflated chambers 66, 68, and 70 may have a tubular shape. The first inflated chamber 66 has a first longitudinal axis 72, the second inflated chamber 68 has a second longitudinal axis 74, and the third inflated chamber 70 has a third longitudinal axis 76. The first, second, and third longitudinal axes 72, 74, and 76 extend in the lateral direction of the vehicle 10. In this regard, FIG. 1 shows an end view of the airbag cushion 64. The first, second, and third inflated chambers 66, 68, and 70 may be in fluid communication with each other and may be formed by a single fabric panel or multiple fabric panels. Although the airbag cushion 64 is shown as including three inflated chambers, the airbag cushion 64 may include 1, 2, 4, or more inflated chambers.

In the example shown in FIG. 1, the first and second inflated chambers 66 and 68 are disposed beside one another in the longitudinal direction of the vehicle 10 and are located at the same height relative to the floor panel 12. The third inflated chamber 70 is disposed below the first and second inflated chambers 66 and 68. The third longitudinal axis 76 of the third inflated chamber 70 is disposed between the first and second longitudinal axes 72 and 74 of the first and second inflated chambers 66 and 68, respectively, in the longitudinal direction of the vehicle 10. The first, second, and third inflated chambers 66, 68, and 70 may be arranged in different configurations as discussed in more detail below.

Each of the first and second occupants 40 and 44 has legs 78. When the vehicle 10 is involved in an impact, lower halves 78a of the legs 78 may rotate upward due to the force of the impact. For example, in FIG. 1, the legs 78 of the first and second occupants 40 and 44 are shown using solid lines when the vehicle 10 is not involved in an impact, and the lower halves 78a of the legs 78 of the first occupant 40 are shown rotated upward using a dashed line when the vehicle 10 is involved in the impact.

The airbag cushions 64 of the first and second airbag assemblies 24 and 26 resist this upward motion of the lower halves 78a of the legs 78 when the vehicle 10 is involved in an impact and the airbag cushions 64 are deployed. The first airbag assembly 24 is located within the first door 20 so that the airbag cushion 64 of the first airbag assembly 24 is positioned to resist the upward motion of the legs 78 of the first occupant 40 when the airbag cushion 64 is deployed. To this end, the height of the first airbag assembly 24 relative to the floor panel 12 and/or the distance between the first airbag assembly 24 and the first seat 14 may be selected so that the airbag cushion 64 blocks the travel path of the lower halves 78a of the legs 78. For example, the first airbag assembly 24 may be located within the first door 20 so that a portion of the airbag cushion 64 is at the same height as a top surface 80 of the bottom 32 of the first seat 14. Although the third inflated chamber 70 of the airbag cushion 64 of the first airbag assembly 24 is shown contacting ankles 78b of the legs 78 of the first occupant 40, the height, longitudinal location, and/or geometry of the first airbag assembly 24 may be adjust to yield a different contact point.

Similarly, the second airbag assembly 26 is located within the second door 22 so that the airbag cushion 64 of the second airbag assembly 26 is positioned to resist the upward motion of the legs 78 of the second occupant 44 when the airbag cushion 64 is deployed. To this end, the height of the second airbag assembly 26 relative to the floor panel 12 and/or the distance between the second airbag assembly 26 and the second seat 16 may be selected so that the airbag cushion 64 blocks the travel path of the lower halves 78a of the legs 78. For example, the second airbag assembly 26 may be located within the second door 22 so that a portion of the airbag cushion 64 is at the same height as a top surface 82 of the bottom 32 of the second seat 16.

Although the vehicle 10 is shown as including the first and second airbag assemblies 24 and 26 for the first and second occupants 40 and 44, respectively, the vehicle 10 may include only one of the first and second airbag assemblies 24 and 26 for both the first and second occupants 40 and 44. For example, if only the first airbag assembly 24 is included, the first airbag assembly 24 may be located equidistant between the first and second seats 14 and 16, and the deployed airbag cushion 64 of the first airbag assembly 24 may limit the upward motion of the legs 78 of both the first and second occupants 40 and 44. In addition, the line between the first and second doors 20 and 22 may be move to a location other than equidistant between the first and second seats 14 and 16 so that the first airbag assembly 24 may be mounted in one of the first and second doors 20 and 22.

In various implementations, a single one of the first and second airbag assemblies 24 and 26 may be used to limit the upward motion of the legs of two or more occupants that are sitting side-by-side in the vehicle 10. For example, the length of the airbag cushion 64 may be increased so that the airbag cushion extends in the leg area (e.g., above the feet) of two occupants instead of a single occupant as described above. Alternatively, a single one of the first and second airbag assemblies 24 and 26 may be used to limit the upward motion of the legs of one occupant and one leg of another occupant sitting beside the one occupant.

The airbag control module 28 controls an inflator in each of the first and second airbag assemblies 24 and 26 to deploy the airbag cushion 64 therein when the vehicle 10 is involved in an impact or collision. The airbag control module 28 determines whether the vehicle 10 is involved in an impact based on an input from one or more accelerometers 84, one or more pressure sensors 86, and/or one or more gyroscopes 88. Each accelerometer 84 measures the acceleration of the vehicle 10 and outputs a signal indicating the vehicle acceleration. Each pressure sensor 86 measures the pressure of air within a side wall or door of the vehicle 10 (e.g., in the space between the inner panel 46 and the outer panel of the body side wall 18) and outputs a signal indicating the pressure. Each gyroscope 88 measures the angular velocity of the vehicle 10 and outputs a signal indicating the vehicle angular velocity.

The airbag control module 28 may not control the inflator to deploy the airbag cushion 64 of the first airbag assembly 24 when the vehicle 10 is involved in an impact if an occupant is not present in the first seat 14. Similarly, the airbag control module 28 may not control the inflator to deploy the airbag cushion 64 of the second airbag assembly 26 when the vehicle 10 is involved in an impact if an occupant is not present in the second seat 16. The airbag control module 28 may determine whether occupants are present in the first and second seats 14 and 16 based on an input from a weight sensor 90, a capacitive sensor 92, a pressure sensor 93, and/or a camera 94.

The weight sensor 90 measures the weight of an object present in the first seat 14 and generates a signal indicating the weight. The capacitive sensor 92 measures the capacitance of an object present in the second seat 16 and generates a signal indicating the capacitance. The pressure 93 measures the pressure exerted on a bladder by an object present in the second seat 16 and generates a signal indicating the pressure. The camera 94 obtains an image of an object present in the first seat 14 and/or the second seat 16 and generates a signal indicating the image. Although the weight sensor 90 is shown in the first seat 14, the capacitive sensor 92 is shown in the second seat 16, and the pressure sensor 93 is shown in the second seat 16, each of the first and second seats 14 and 16 may include the weight sensor 90, the capacitive sensor 92, and/or the pressure sensor 93. The camera 94 can be mounted on the roof of the vehicle 10, the side walls of the vehicle 10, or other locations in the vehicle that provide a suitable mounting surface for the camera 94. One or more cameras can also be used in the same or different locations. Other technologies for sensing the presence of an occupant may be used in addition to or instead of those discussed above.

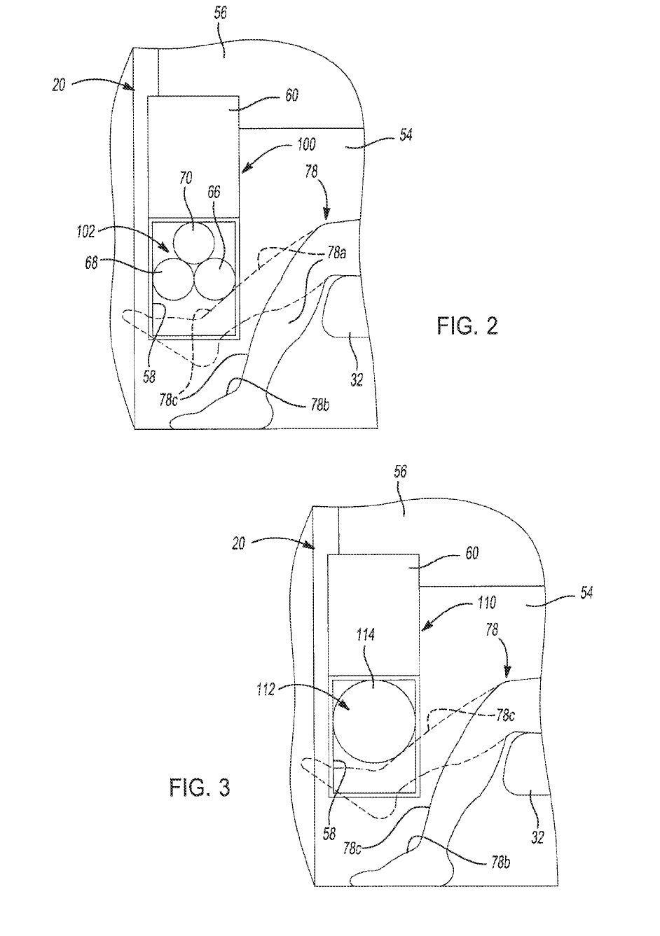

Referring now to FIG. 2, another example airbag assembly 100 is shown. The airbag assembly 100 may be used in place of the first or second airbag assemblies 24 or 26 of FIG. 1. The airbag assembly 100 is substantially similar to the airbag assemblies 24, 26 except that the airbag assembly 100 includes an elongated airbag cushion 102 that is different than the airbag cushion 64. The airbag cushion 102 is inverted in a vertical direction of the vehicle 10 relative to the airbag cushion 64. Thus, the third inflated chamber 70 is disposed above the first and second inflated chambers 66 and 68 rather than below the first and second inflated chambers 66 and 68. As a result, the first inflated chamber 66 of the airbag cushion 102 contacts higher on the legs 78 of the first occupant 40, such as contacting the shins 78c of the first occupant 40 rather than the third inflated chamber 70 contacting the ankles 78b of the first occupant 40 as shown in FIG. 1.

Referring now to FIG. 3, another example airbag assembly 110 is shown. The airbag assembly 110 may be used in place of the first or second airbag assemblies 24 or 26 of FIG. 1. The airbag assembly 110 is substantially similar to the airbag assemblies 24, 26 except that the airbag assembly 110 includes an elongated airbag cushion 112 that is different than the airbag cushion 64. The airbag cushion 112 includes only a single inflated chamber 114 having a tubular shape rather than three inflated chambers with tubular shapes. As a result, the airbag cushion 112 contacts higher on the legs 78 of the first occupant 40, such as contacting the shins 78c of the first occupant 40 rather than contacting the ankles 78b of the first occupant 40 as shown in FIG. 1.

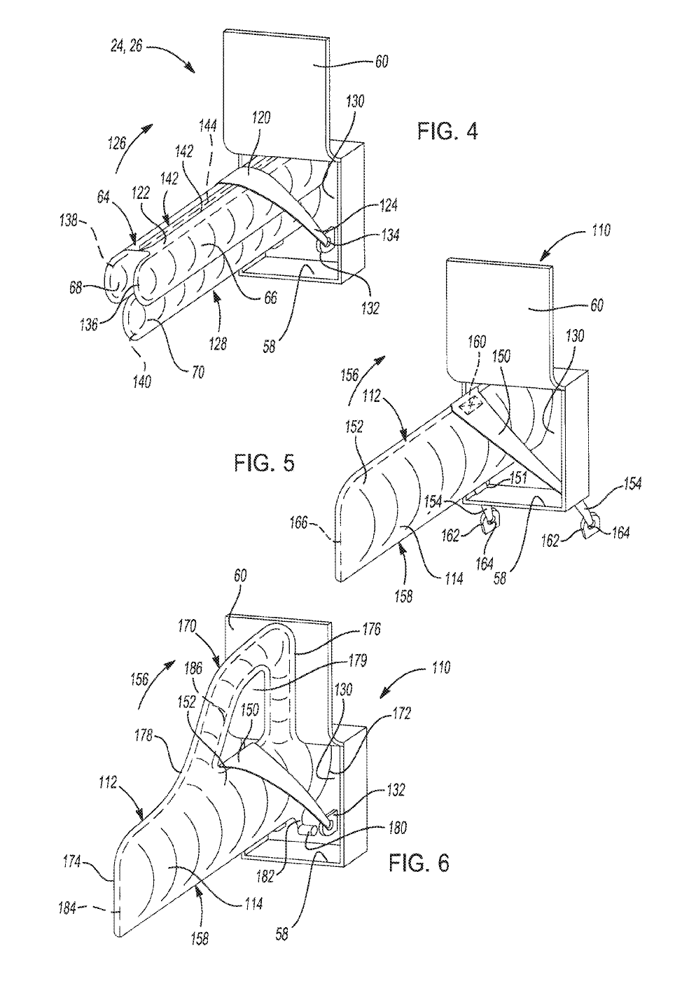

Referring now to FIG. 4, an example implementation of the airbag assembly 24 or 26 of FIG. 1 further includes a tether 120 that wraps around a top surface 122 of the airbag cushion 64 and has opposite ends 124 (only one shown) that are fixed within the housing 58. The tether 120 prevents the airbag cushion 64 from rotating in a direction 126 when the legs 78 of the first or second occupant 40 or 44 contact an underside surface 128 of the airbag cushion 64. Each end 124 of the tether 120 is attached to a mounting plate 130 of the housing 58 via mounting tabs 132. The mounting tabs 132 project from the mounting plate 130 of the housing 58 and have holes 134 for mounting the tether 120. In one example, each end 124 of the tether 120 is routed through the hole 134 in one of the mounting tabs 132 and is sewn to another portion of the tether 120 to secure the tether 120 to the mounting tabs 132. The mounting tabs 132 may be integrally formed with the mounting plate 130 (i.e., the mounting tabs 132 may be part of the mounting plate 130) or the mounting tabs 132 may be formed separate from the mounting plate 130 and attached to the mounting plate 130 using one or more fasteners such as threaded fasteners.

The example implementation of the airbag cushion 64 shown in FIG. 4 further includes a first seam 136, a second seam 138, a third seam 140, tabs 142, and a fourth seam 144. The first seam 136 seals the outer perimeter of the first inflated chamber 66. The second seam 138 seals the outer perimeter of the second inflated chamber 68. The third seam 140 seals the outer perimeter of the third inflated chamber 70. In various implementations, the first seam 136, the second seam 138, and the third seam 140 may all be part of a single continuous seam. Each tab 142 projects upward from one of the first and second inflated chambers 66 and 68, and the fourth seam 144 joins the tabs 142 to one another.

Referring now to FIG. 5, an example implementation of the airbag assembly 110 of FIG. 3 further includes a tether 150 that wraps around a top surface 152 of the airbag cushion 112 and has opposite ends 154 that are fixed outside of the housing 58. The tether 150 prevents the airbag cushion 112 from rotating in a direction 156 when the legs 78 of the first or second occupant 40 or 44 contact an underside surface 158 of the airbag cushion 112. The tether 150 is attached to the top surface 152 of the airbag cushion 112 using, for example, stitching 160.

Each end 154 of the tether 150 may be fixed directly to the housing 58 or to the inner panel 54 (FIG. 1) via mounting tabs 162. The mounting tabs 162 may be part of the housing 58 or the inner panel 54 and may have holes 164 for mounting the tether 150. In one example, each end 152 of the tether 150 is routed through a passageway 151 in the housing 58 and the hole 164 in one of the mounting tabs 162 and is sewn to another portion of the tether 150 to secure the tether 150 to the mounting tabs 162. The example implementation of the airbag cushion 112 shown in FIG. 5 further includes a seam 166 that seals the outer perimeter of the inflated chamber 114.

Referring now to FIG. 6, another example implementation of the airbag assembly 110 is similar to the example implementation of the airbag assembly shown in FIG. 5 except that the airbag cushion 112 further includes an inflated foot 170. Also, the tether 150 is not attached to the top surface 152 of the airbag cushion 152, and the opposite ends 154 of the tether 150 are fixed to the mounting tabs 132 within the housing 58 rather than the mounting tabs 162 outside of the housing 58. However, the tether 150 may be attached to the airbag cushion 112 as shown in FIG. 5. In FIG. 6, the inflated foot 170 prevents the airbag cushion 112 from rotating in the direction 156 when the legs 78 of the first or second occupant 40 or 44 contact the underside surface 158 of the airbag cushion 112. When the legs 78 contact the underside surface 158, the inflated foot 170 pushes on the door 60 and the inner panel 54, and the inner panel 54 acts as a reaction surface for the inflated foot 170 to prevent rotation of the airbag cushion 112 in the direction 56. In addition, the inflated foot 170 maintains the door 60 in the open position when the airbag cushion 112 is inflated.

The airbag cushion 112 has a first end 172 that is fixed to the housing 58 and a second end 174 opposite of the first end 172. In FIG. 6, the inflated foot 170 has a vertical portion 176 and an angled portion 178. The vertical portion 176 is disposed adjacent to the first end 172 of the airbag cushion 112 and projects from the top surface 152 of the airbag cushion 112. The angled portion 178 projects from the top surface 152 of the airbag cushion 112 to the vertical portion 176. The vertical portion 176, the angled portion 178, and the top surface 152 of the airbag cushion 112 form an opening 179 in the airbag cushion 112 therebetween. The inflated foot 170 may have a different shape than the shape shown in FIG. 6. For example, the inflated foot 170 may have the shape of a triangle with no holes in the triangle (i.e., the entire triangular-shaped inflated foot 170 may be inflated).

The example implementation of the airbag assembly 110 shown in FIG. 6 further includes an inflator 180, a fabric inflation tube 182, an outer seam 184, and an inner seam 186. The inflator 180 inflates the airbag cushion 112 in response to a control signal from the airbag control module 28. The fabric inflation tube 182 delivers gas from the inflator 180 to the airbag cushion 112. The outer seam 184 seals the outer perimeter of the airbag cushion 112, and the inner seam 186 seals the inner perimeter of the airbag cushion 112 that extends around the opening 179.

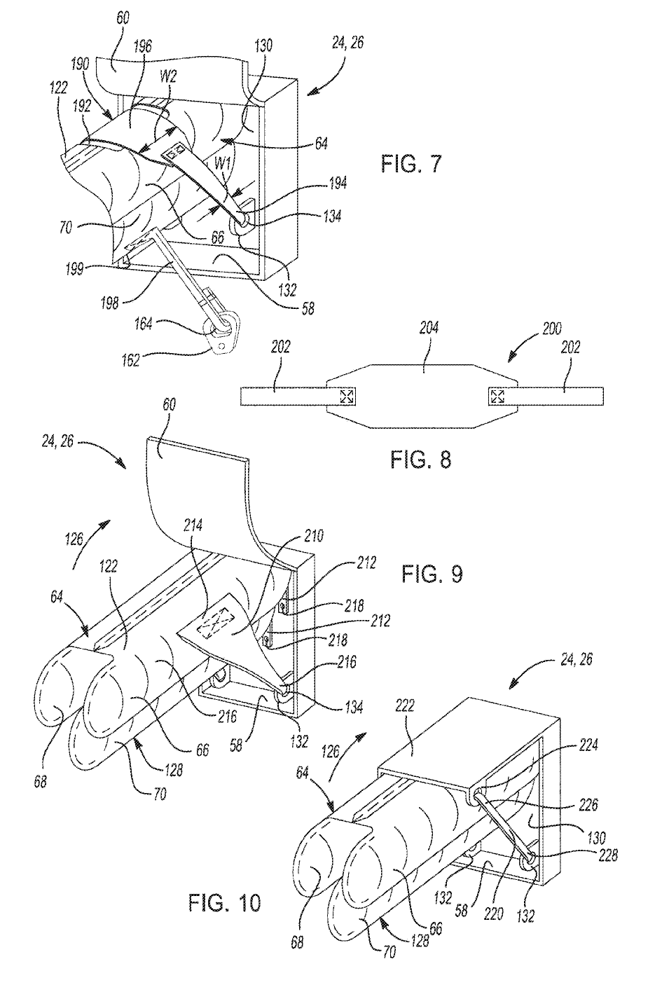

Referring now to FIG. 7, an example implementation of the airbag assembly 24 or 26 is shown that is similar to the example implementation of the airbag assembly 24 or 26 shown in FIG. 4. However, the example implementation shown in FIG. 7 includes a tether 190 in place of the tether 120, and a pad 192 is placed between the tether 190 and the top surface 122 of the airbag cushion 64. Similar to the tether 120, the tether 190 wraps around the top surface 122 of the airbag cushion 64 and has opposite ends 194 (only one shown) that are fixed within the housing 58. However, in contrast to the tether 120, a center portion 196 of the tether 190 (i.e., the portion of the tether 190 disposed midway between the ends 192) is substantially wider than the remainder of the tether 190. In one example, the tether 190 has a first width W1 adjacent to the ends 194, and the tether 192 has a second width W2 in the center portion 196 that is N times greater than the first width W1, where N is an integer greater than 1.25 (e.g., 1.5, 1.75, 2, 2.25, 2.5).

This additional width in the center portion 196 of the tether 190 distributes the force applied by the tether 190 to a greater area of the top surface 122 of the airbag cushion 64. Similarly, the pad 192 distributes the force applied by the tether 190 to a greater area of the top surface 122 of the airbag cushion 64. The pad 192 may be attached (e.g., sewn) to the top surface 122 of the airbag cushion 64, to the tether 190, or to both the top surface 122 of the airbag cushion 64 and the tether 190. The example implementation shown in FIG. 7 also includes an optional bottom tether 198 that is attached (e.g., sewn) to a bottom surface 199 of the third inflated chamber 70, routed through the hole 164 in the mounting tab 162, and attached (e.g., sewn) to itself. The mounting tab 162 may be fixed directly to the housing 58, to the inner panel 54 (FIG. 1) or to any vehicle structure nearby.

Referring now to FIG. 8, an example tether 200 is shown that is similar to the tether 190 of FIG. 7 except that, while the tether 190 is a single piece, the tether 200 includes multiples pieces that are joined to one another. In this regard, the tether 200 includes a pair of strips 202 attached (e.g., sewn) to opposite ends of a center portion 204. The strips 202 may be made from seatbelt webbing material, and the center portion 204 may be made from a fabric that is more flexible than seatbelt webbing material. Each of the strips 202 may include a loop (not shown) reinforced by a mounting tab (not shown) for fastening the tether 200 to the vehicle 10.

Referring now to FIG. 9, another example implementation of the airbag assembly 24 or 26 is shown that is similar to the example implementation of the airbag assembly 24 or 26 shown in FIG. 4. However, the example implementation shown in FIG. 9 includes a pair of tethers 210 in place of the tether 120, and the airbag cushion 64 includes fabric mounting tabs 212 extending downward from the first, second, and third inflated chambers 66, 68, and 70. The mounting tabs 212 may also extend in other directions.

Each tether 210 has a first end 214 attached to a side surface 216 of the airbag cushion 64, and a second end 216 attached to the housing 58 via one of the mounting tabs 32. Thus, like the tether 120, the tethers 210 prevent the airbag cushion 64 from rotating in the direction 126 when the legs 78 of the first or second occupant 40 or 44 contact the underside surface 128 of the airbag cushion 64. However, in contrast to the tether 120, the tethers 210 do not wrap over the top surface 122 of the airbag cushion 64. Each fabric mounting tab 212 has a hole 218 for receiving a fastener to mount the airbag cushion 64 to the housing 58.

Referring now to FIG. 10, another example implementation of the airbag assembly 24 or 26 is shown that is similar to the example implementation of the airbag assembly 24 or 26 shown in FIG. 4. However, the example implementation shown in FIG. 10 includes a pair of tethers 220 (only one shown) in place of the tether 120, and includes a door 222 in place of the door 60. The door 222 may be made from a more rigid and/or stronger material than the door 60. For example, while the door 60 may be made from TPO as described above, the door 222 may also have an insert or stiffener, such as underside ribs made of a stronger material than the remainder of the door 222, and the insert or stiffener may be molded as part of the door 222 or formed separate from the door 222 and attached to the door 222. In FIG. 10, the door 222 also includes a pair of mounting tabs 224 projecting from an inside surface 226 of the door 222.

Each tether 220 has a first end 226 attached to the door 222 via one of the mounting tabs 224, and a second end 228 attached to the housing 58 via one of the mounting tabs 132. Thus, like the tether 120, the tethers 220 prevent the airbag cushion 64 from rotating in the direction 126 when the legs 78 of the first or second occupant 40 or 44 contact the underside surface 128 of the airbag cushion 64. However, the tethers 220 are not wrapped around the airbag cushion 64. Instead, the tethers 220 limit the amount by which the door 222 pivots in the direction 126 when the airbag cushion 64 is deployed, and the door 222 contacts the top surface 120 of the airbag cushion 64 to limit rotation of the cushion 64 in the direction 126.

Other configurations of the tethers 220 and the door 222 are also possible. For example, the mounting tabs 224 can be made from metal and/or can be molded in the door 222. Additionally or alternatively, the door 222 can define a channel, and a single continuous tether can be used in place of the tethers 220 and can be routed through the channel and have opposite ends attached to the mounting tabs 132. Further, the channel can be formed using a stiff additional piece that is molded in the door 222 or fastened to the door 222.

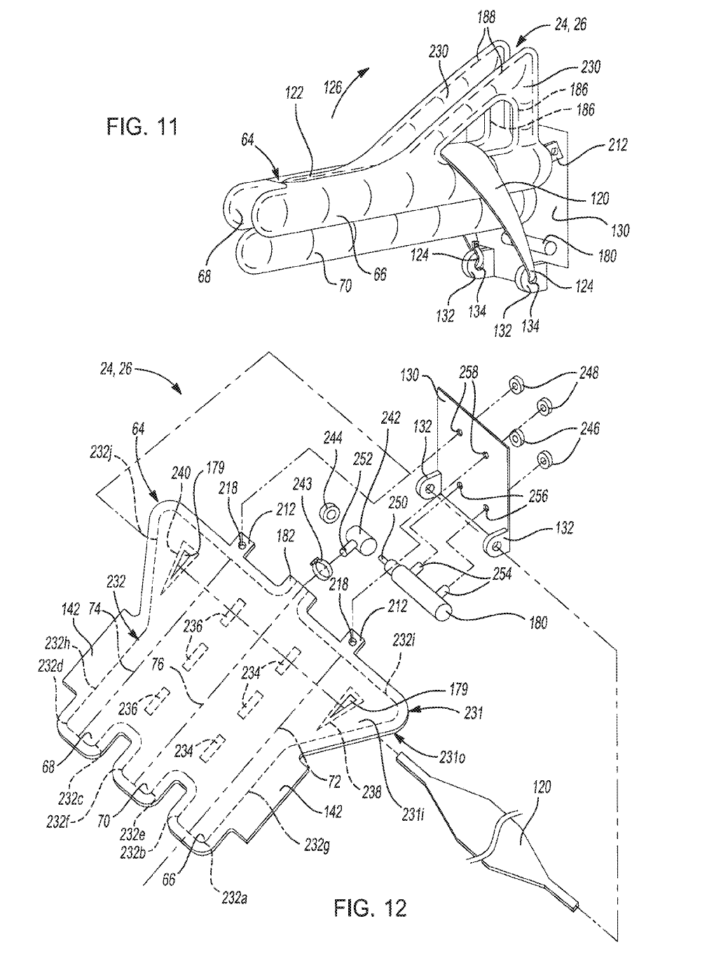

Referring now to FIG. 11, another example implementation of the airbag assembly 24 or 26 is shown that is similar to the example implementation of the airbag assembly 24 or 26 shown in FIG. 4. However, the example implementation of the airbag assembly 24 or 26 shown in FIG. 11 includes a pair of inflated feet 230, the inflator 180, and the mounting tabs 212. One of the inflated feet 230 projects from the top surface 122 of the first inflated chamber 66, and the other one of the inflated feet 230 projects from the top surface 122 of the second inflated chamber 68. The inflated feet 230 cooperate with the tether 120 to limit rotation of the airbag cushion 64 in the direction 126.

Referring now to FIG. 12, an example implementation of the airbag assembly 24 or 26 is shown in a disassembled state and a pair of fabric panels 231 is shown in a flat state before an inner fabric panel 231i of the fabric panels 231 and an outer fabric panel 2310 of the fabric panels 231 are joined together to form the airbag cushion 64. Although only a small portion of the outer fabric panel 2310 is shown in FIG. 12, the outer fabric panel 2310 may be similar or identical to the inner fabric panel 231i.

An outer perimeter 232 of the fabric panels 231 is sewn together at various locations to form the three-dimensional structure shown in FIG. 11. For example, first and second portions 232a and 232b of the outer perimeter 232 on opposite sides of the first longitudinal axis 72 are sewn together to form the first seam 136 of the first inflated chamber 66. Third and fourth portions 232c and 232d of the outer perimeter 232 on opposite sides of the second longitudinal axis 74 are sewn together to form the second seam 138 of the second inflated chamber 68.

Fifth and sixth portions 232e and 232f of the outer perimeter 232 disposed on opposite sides of the third longitudinal axis 76 are sewn together to form the third seam 140 of the third inflated chamber 70. Seventh and eighth portions 232g and 232h of the outer perimeter 232 are sewn together to form the top surface 122 of the airbag cushion 64. Ninth and tenth portions 232i and 232j of the outer perimeter 232 are sewn together to form an outer boundary of the inflated foot 170, which projects from the top surface 122 of the airbag cushion 64.

In addition, various portions of the airbag cushion 68 disposed within the outer perimeter 232 are joined together to seal the airbag cushion 68. For example, first rectangular portions 234 on the inner fabric panel 231i are sewn to the first rectangular portions 234 on the outer fabric panel 2310 to form seams that define a boundary between the first and third inflated chambers 66 and 70. Gas passages extend between the first rectangular portions 234 and place the first and third inflated chambers 66 and 70 in fluid communication with one another. In another example, second rectangular portions 236 on the inner fabric panel 231i are sewn to the second rectangular portions 236 on the outer fabric panel 2310 to form seams that define a boundary between the second and third inflated chambers 68 and 70. Gas passages extend between the second rectangular portions 236 and place the second and third inflated chambers 68 and 70 in fluid communication with one another. In another example, a first triangular portion 238 and a second triangular portion 240 on the inner fabric panel 231i are respectively sewn to the first triangular portion 238 and the second triangular portion 240 on the outer fabric panel 2310 to form the inner seam 186 of the inflated foot 170. In other examples, the first rectangular portions 234 may be sewn to the second rectangular portions 236 and/or the first triangular portions 238 may be sewn to the second triangular portions 240. Further, the airbag cushion 64 may be formed by weaving and one or more (e.g., all) of the sewing steps discussed above may be integrated into the process of weaving the airbag cushion 64.

The example implementation of the airbag assembly 24 or 26 shown in FIG. 12 further includes an elbow fitting 242, a cushion clamp 243, a fitting nut 244, a pair of inflator nuts 246, and a pair of cushion nuts 248. The elbow fitting 242 directs gas from the inflator 180 to the airbag cushion 64. The fitting nut 244 is threaded onto a threaded rod 250 on the inflator 180 to secure the elbow fitting 242 to the inflator 180. The cushion clamp 243 may be used to secure a male end 252 of the elbow fitting 242 within the fabric inflating tube 182.

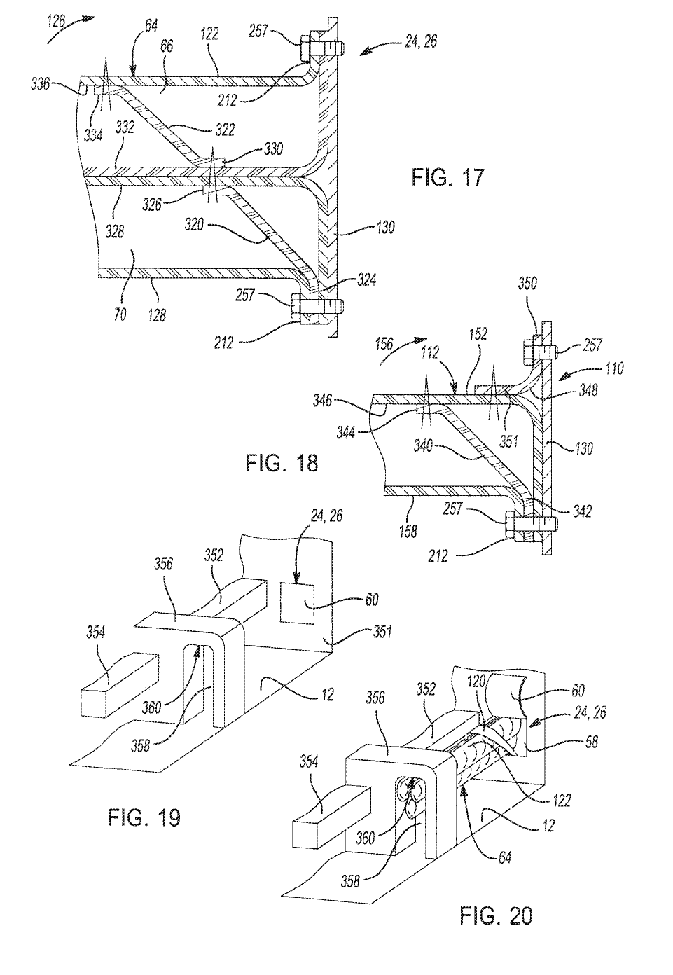

A pair of threaded rods 254 on the inflator 180 are inserted through holes 256 in the mounting plate 130, and the inflator nuts 246 are threaded onto the threaded rods 254 to secure the inflator 180 to the mounting plate 130. A pair of bolts 257 (FIG. 17) are inserted through holes 218 in the mounting tabs 212 and through holes 258 in the mounting plate 130. The cushion nuts 248 are then threaded onto the bolts to secure the airbag cushion 64 to the mounting plate 130.

In FIGS. 11 and 12, the mounting plate 130 is shown as having a generally rectangular shape and the two mounting tabs 212 are shown at the top of the airbag cushion 64. However, the mounting plate 130 can have any shape that interfaces with the vehicle 10, the airbag cushion 64, and the inflator 180. In addition, the mounting tabs 212 can be located on any portion of the airbag cushion 64 that interfaces with the mounting plate 130. Further, the embodiments of FIGS. 11 and 12 do not include the housing 58 or the door 60. However, the housing 58 and/or the door 60 may be integrated into to the side wall 18, the inner panel 54 of the first or second door 20 or 22, the outer panel of the first or second door 20 or 22, or an intermediate structure of the first or second door 20 or 22 disposed between the inner panel 54 and the outer panel. In addition, a fabric wrap cover (not shown) may be used in place of the door 60, and the fabric wrap cover may have a weakened area or tear seam through which the airbag cushion 64 deploys.

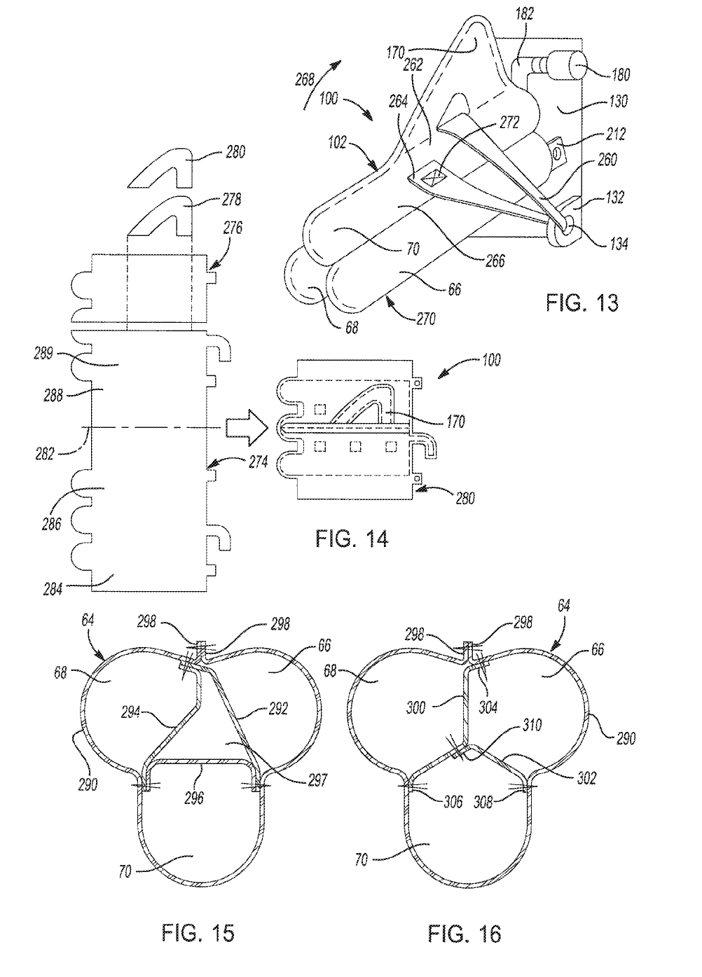

Referring now to FIG. 13, an example implementation of the airbag assembly 100 of FIG. 2 includes the inflated foot 170, the inflator 180, the fabric inflation tube 182, and a tether 260. The inflated foot 170 is part of the airbag cushion 102 which includes the first, second, and third inflated chambers 66, 68, and 70, and the inflated foot 170 projects from the third inflated chamber 70. The tether 260 wraps around a top surface 262 of the airbag cushion 102 and through the holes 134 in the mounting tabs 132 on the mounting plate 130, and has opposite ends 264 (only one shown) that are fixed to a side surface 266 of the airbag cushion 102. The tether 260 prevents the airbag cushion 102 from rotating in a direction 268 when the legs 78 of the first or second occupant 40 or 44 contact an underside surface 270 of the airbag cushion 102. The tether 260 is attached to the side surface 266 of the airbag cushion 102 using, for example, stitching 272. Portions of the tether 260 adjacent to and on opposite sides of each mounting tab 132 may be sewn together so that the tether 260 cannot slide with respect to the holes 134 in the mounting tabs 132.

Referring now to FIG. 14, an example implementation of the airbag assembly 100 is shown in a disassembled state and a number of fabric panels are shown in a flat state before the fabric panels are joined (e.g., sewn) together to form the airbag cushion 102. In contrast to the example implementation of the airbag cushion 64 shown in FIG. 12, the example implementation of the airbag cushion 102 shown in FIG. 13 is formed from multiple pieces of fabric that are joined together. The fabric pieces include a first fabric panel 274, a second fabric panel 276, a third fabric panel 278, and a fourth fabric panel 280.

The first fabric panel 274 is folded along a fold line 282 and a portion 284 of the first fabric panel 274 forms the inner sides of the first, second, and third inflated portions 66, 68, and 70 shown in FIG. 13. The first fabric panel 274 may be a single piece, or a fourth fabric panel 286 and a fifth fabric panel 288 may be joined (e.g., sewn) together to form the first fabric panel 274. A portion 289 of the first fabric panel 274 and the second fabric panel 276 are sewn together to form the outer sides of the first, second, and third inflated portions 66, 68, and 70 shown in FIG. 13. The portions 284 of the first fabric panel 274 and the subassembly consisting of the portion 289 of the first fabric panel 274 and the second fabric panel 276 are sewn together to form the airbag cushion 102 shown in FIG. 11 similar to the manner in which portions of the fabric panel 231 of FIG. 12 are sewn together to form the airbag cushion 64.

The third and fourth fabric panels 278 and 280 are joined together to form the inflated foot 170, and the third and fourth fabric panels 278 and 280 are joined to the joint between the first fabric panel 274 and the second fabric panel 276 to attach the inflated foot 170 to the third inflated chamber 70. The third and fourth fabric panels 278 and 280 may be joined together before or after the third and fourth fabric panels 278 and 280 are joined to the joint between the first fabric panel 274 and the second fabric panel 276.

Referring now to FIG. 15, another example implementation of the airbag assembly 24 or 26 is shown. In contrast to FIG. 12, in FIG. 15, the boundaries between the first, second, and third inflated chambers 66, 68, and 70 are formed using tethers disposed within the airbag cushion 64. More specifically, the outer surface of the airbag cushion 64 is formed by a fabric panel 290, and first, second, and third tethers 292, 294, and 296 are joined to the inner surface of the fabric panel 290 at various locations to form the first, second, and third inflated chambers 66, 68, and 70. In addition, the first, second, and third tethers 292, 294, and 296 form a fourth chamber 297 therebetween, which may or may not be inflated.

The fabric panel 290 has opposite ends 298 that are sewn together to seal the interior of the airbag cushion 64. The first and second tethers 292 and 294 are sewn together and to the inner surface of the fabric panel 290 to form the boundary between the first and second inflated chambers 66 and 68. Alternatively, the first and second tethers 292 and 294 can be sewn together and to the sewn joint between the opposite ends 298 of the fabric panel 290 to form the boundary between the first and second inflated chambers 66 and 68. The first and third tethers 292 and 296 are sewn together and to the inner surface of the fabric panel 290 to form the boundary between the first and third inflated chambers 66 and 70. The second and third tethers 294 and 296 are sewn together and to the inner surface of the fabric panel 290 to form the boundary between the second and third inflated chambers 68 and 70.

Referring now to FIG. 16, another example implementation of the airbag assembly 24 or 26 is shown where the boundaries between the first, second, and third inflated chambers 66, 68, and 70 are formed using tethers disposed within the airbag cushion 64. However, fewer tethers are used to form these boundaries in FIG. 16 than in FIG. 15, and the tethers are arranged differently in FIG. 16 relative to FIG. 15. More specifically, in FIG. 16, a first tether 300 and a second tether 302 are joined to the inside surface of the airbag cushion 64 at various locations to form the boundaries between the first, second, and third inflated chambers 66, 68, and 70.

The first tether 300 has a first end 304 and a second end 306 opposite of the first end 304. The first end 304 of the first tether 300 is joined to the inner surface of the fabric panel 290 to form the boundary between the first and second inflated chambers 66 and 68. Alternatively, the first end 304 of the first tether 300 can be sewn to the sewn joint between the opposite ends 298 of the fabric panel 290. The second end 306 of the first tether 300 is joined to the inner surface of the fabric panel 290 to form the boundary between the second and third inflated chambers 68 and 70.

The second tether 302 has a first end 308 and a second end 310 opposite of the first end 308. The first end 308 of the second tether 302 is joined to the inner surface of the fabric panel 290 to form the boundary between the first and third inflated chambers 66 and 70. The second end 310 of the second tether 302 is joined to first tether 300 at a location that is midway between the first and second ends 304 and 306 of the first tether 300. Thus, in both FIGS. 15 and 16, the tethers apply a tension force on the inside surface of the inflated fabric panel 290 at various locations to form the boundaries between the first, second, and third inflated chambers 66, 68, and 70.

Referring now FIG. 17, an example implementation of the airbag assembly 24 or 26 is shown that includes first and second tethers 320 and 322 disposed within the airbag cushion 64. The first and second tethers 320 and 322 prevent the airbag cushion 64 from rotating in the direction 126 when the legs 78 of the first or second occupant 40 or 44 contact the underside surface 128 of the airbag cushion 64. The first tether 320 has a first end 324 attached to the mounting plate 130 using one of the bolts 257 and a second end 326 sewn to an upper inner surface 328 of the third inflated chamber 70. Alternatively, the first end 324 of the first tether 320 can be sewn into a fabric wall of the third inflated chamber 70. The second tether 322 has a first end 330 sewn to a lower inner surface 332 of the first inflated chamber 66 and a second end 334 sewn to an upper inner surface 336 of the first inflated chamber 66. In addition, the first end 330 of the second tether 322 is sewn to the second end 326 of the first tether 320. A similar tether arrangement can be utilized which includes the second inflated chamber 68.

Referring now to FIG. 18, an example implementation of the airbag assembly 110 is shown that includes a first tether 340 disposed within the airbag cushion 112. The first tether 340 prevents the airbag cushion 112 from rotating in the direction 156 when the legs 78 of the first or second occupant 40 or 44 contact the underside surface 158 of the airbag cushion 112. The first tether 340 has a first end 342 attached to the mounting plate 130 using one of the bolts 257 and a second end 344 sewn to an inner upper surface 346 of the airbag cushion 112. Alternatively, the first end 342 of the first tether 340 can be sewn into a fabric wall of the third inflated chamber 70.

The example implementation of the airbag assembly 110 shown in FIG. 18 further includes a second tether 348 that serves as another mounting tab for the airbag cushion 112. The second tether 348 has a first end 350 and a second end 351 opposite of the first end 350. The first end 350 of the second tether 348 is attached to the mounting plate 130 using one of the bolts 257 that extends through a hole in the second tether 348 adjacent to the first end 350. The second end 351 of the second tether 348 is sewn to the top surface 152 of the airbag cushion 112.

Referring now to FIGS. 19 and 20, the example implementation of the airbag assembly 24 or 26 of FIG. 1 is shown mounted in a side wall 351 of a vehicle. The vehicle includes first and second seats 352 and 354 and a center structure 356, such as a center console, disposed between the seats 352, 354 and acting as an interlocking device. The airbag assembly 24 or 26 and the center structure 356 collectively may be referred to as an airbag system. In FIG. 19, the airbag cushion 64 is not yet deployed and the door 60 is in its closed position. In FIG. 20, the airbag cushion 64 is deployed and the door 60 is in its open position.

As shown in FIG. 20, the airbag cushion 64 extends into a receptacle 358 in the center structure 356 when the airbag cushion 64 is deployed. Thus, if the legs of an occupant in the first seat 352 contact the underside surface 128 of the airbag cushion 64, the center structure 356 prevents the airbag cushion 64 from rotating in the direction 126 out of the travel path of the occupant's legs. More specifically, an underside surface 360 of the center console 356 contacts the top surface 122 of the airbag cushion 64 to prevent the airbag cushion 64 from rotating in the direction 126.

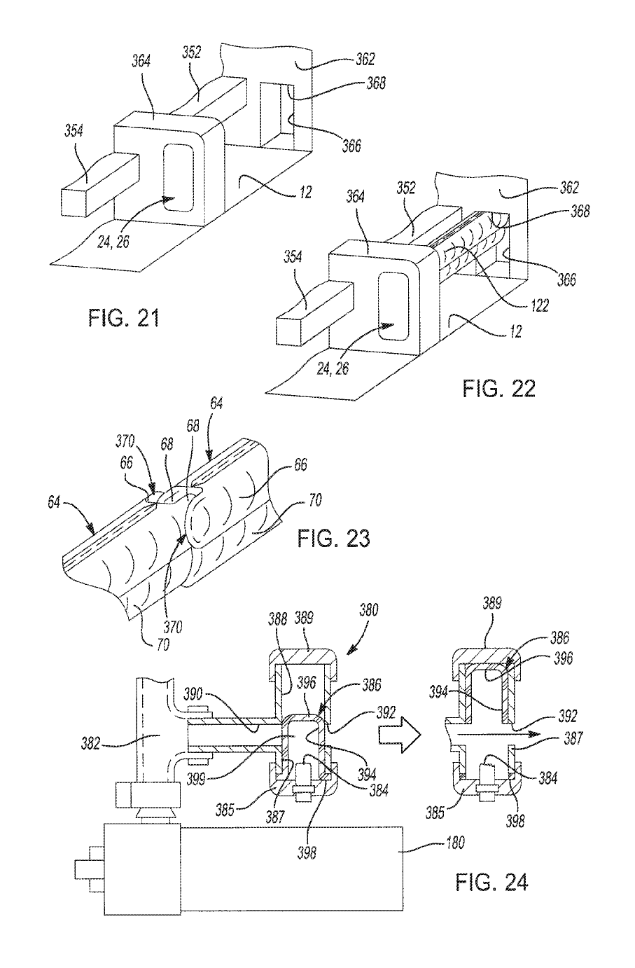

Referring now to FIGS. 21 and 22, the example implementation of the airbag assembly 24 or 26 of FIG. 1 is shown mounted in a side wall 362 of a vehicle that includes the seats 352, 354 and a center structure 364, such as a center console, disposed between the seats 352, 354. In contrast to the airbag system of FIGS. 19 and 20, in FIGS. 21 and 22, the airbag assembly 24 or 26 is mounted in the center structure 364 and the side wall 362 acts as an interlocking device. In FIG. 21, the airbag cushion 64 is not yet deployed. In FIG. 22, and the airbag cushion 64 is deployed and extends into a receptacle 366 in the side wall 362, and contact between an underside surface 368 of the side wall 362 and the top surface 122 of the airbag cushion 64 prevents the airbag cushion 64 from rotating in the direction 126.

Referring now to FIG. 23, example implementations of the airbag assembly 24 or 26 may be mounted in opposite sidewalls of a vehicle so that free ends 370 of the airbag cushions 64 interlock with one another when the airbag cushions 64 are deployed. Thus, the airbag cushions 64 may act as interlocking devices. The free end 370 of each airbag cushion 64 is the end of the airbag cushion 64 opposite of the end of the airbag cushion 64 that is mounted within the housing 58.

In FIG. 23, the second inflated chamber 68 of each airbag cushion 64 extends between the first and second inflated chambers 66 and 68 of the other airbag cushion 64 to yield an interference fit. In addition, the third inflated chamber 70 of each airbag cushion 64 contacts a side of the third inflated chamber 70 of the other airbag cushion 64 and contacts the underside surface of the second inflated chamber 68 of the other airbag cushion 64. Thus, the free ends 370 of the airbag cushions 64 interlock in a manner that resists movement of the airbag cushion 64 in the vertical and longitudinal directions of the vehicle. The interlocking between the airbag cushions 64 may be enhanced by including hook and latch fasteners on the airbag cushions 64 or other fasteners such as one or more magnets whose poles attract one or more other magnets and/or ferrous materials.

Referring now to FIG. 24, an example of a pyrotechnic vent 380 according to the present disclosure is shown connected to a fabric inflation tube 382 that delivers gas from the inflator 180 to an airbag assembly according to the present disclosure. The pyrotechnic vent 380 includes a pyrotechnic device 384, a pyrotechnic retainer 385, a valve 386, a valve retainer 387, a valve receptacle 388, an end cap 389 on the valve receptacle 388, a gas delivery tube 390, and an outlet 392 to the atmosphere. The valve retainer 387, the valve receptacle 388, and the gas delivery tube 390 may be parts of a single component (e.g., a T-shaped fitting). The pyrotechnic device 384 includes an electric igniter and a solid propellant. The valve 386 includes a cylindrical body 394, an end cap 396, and a flange 398 opposite of the end cap 396.

When the pyrotechnic vent 380 is closed as shown in the left side of FIG. 24, the cylindrical body 400 of the valve 386 prevents gas flow from the fabric inflation tube 382 to the outlet 392. In addition, the valve retainer 387 traps the flange 398 of the valve 386 to prevent the valve 386 from moving into the valve receptacle 388. When the pyrotechnic vent 380 is open as shown in the left side of FIG. 24, the valve 386 is disposed in the valve receptacle 388, and therefore gas is allowed to flow from the fabric inflation tube 382 to the outlet 392 through the gas delivery tube 390.

To open the pyrotechnic vent 380, the electric igniter in the pyrotechnic device 384 ignites the solid propellant in the pyrotechnic device 384, which increase the pressure in a space 399 enclosed by the valve 386. This pressure causes the flange 398 to break from the cylindrical body 394 or deform, which allows the valve 386 to move into the valve receptacle 388. Once the valve 386 is in the valve receptacle 388, the pyrotechnic vent 380 is open. The pyrotechnic vent 380 opens in response to a control signal from the airbag control module 28 of FIG. 1.

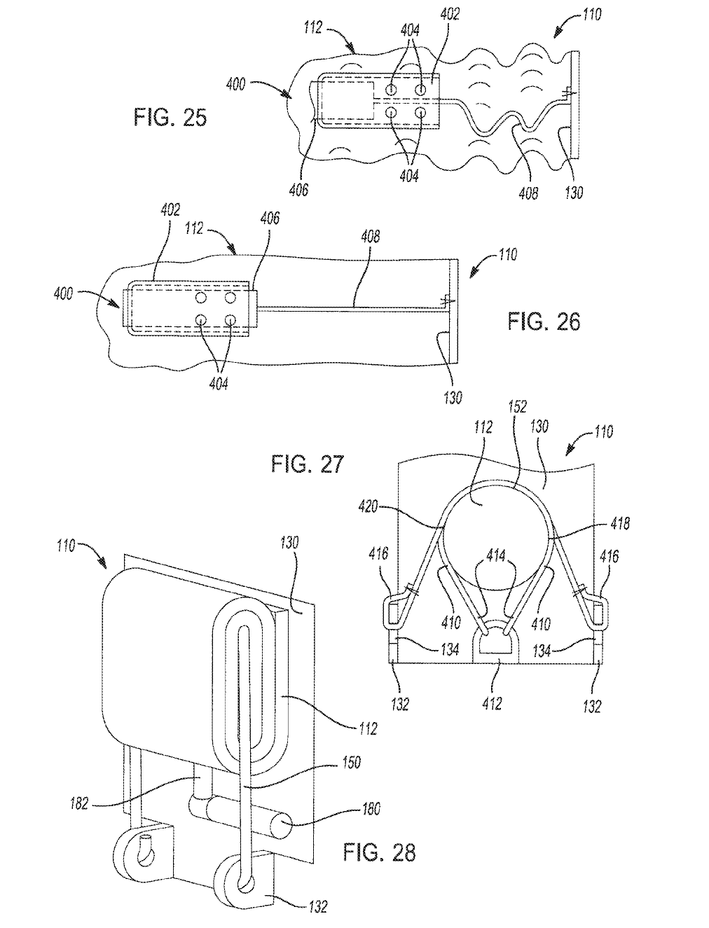

Referring now to FIGS. 25 and 26, an example of a tethered vent 400 according to the present disclosure is shown in the airbag assembly 110 of FIG. 3. The tethered vent 400 includes a guide plate 402 having holes 404, a cover 406, and a tether 408. The guide plate 402 is attached to the airbag cushion 112, and the holes 404 in the guide plate 402 allow gas to exit the airbag cushion 112 when the airbag cushion 112 is not fully deployed as shown in FIG. 25. Thus, the tethered vent 400 allows gas to be released from the airbag cushion 112 if deployment of the airbag cushion 112 is blocked. The cover 406 may be folded upon itself, is slidably coupled to the guide plate 402 and covers the holes 404 to prevent gas from escaping the airbag cushion 112 when the airbag cushion 112 is fully deployed as shown in FIG. 26. The cover 406 or the tether 408 may be tack stitched with tack stitching 407 to the guide plate 402, the cushion 112, or both the guide plate 402 and the cushion 112. The tether 408 connects the cover 406 to the mounting plate 130 so that, when the airbag cushion 112 is fully deployed, the cover 406 is pulled by the tether 408, the tack stitching 407 rips, and the cover 406 slides within the guide plate 402 from the position shown in FIG. 25 to the position shown in FIG. 26.

Referring now to FIG. 27, an example implementation of the airbag assembly 110 of FIG. 5 is shown with a pair of tethers 410 in place of the tether 150 and a mounting tab 412 projecting from the mounting plate 130. Each tether 410 wraps around the top surface 152 of the airbag cushion 112. In addition, each tether has a first end 414 attached to the mounting tab 412 and a second end 416 attached to one of the mounting tabs 132. Thus, due to their angled orientation, the tethers 410 maintain the airbag cushion 112 in the position shown in FIG. 27 when the legs of an occupant contact the airbag cushion 112 at an angle regardless of whether the occupant is disposed on a first or second side 418 or 420 of the airbag cushion 112.

Referring now to FIG. 28, an example of the airbag assembly 110 of FIG. 5 is shown with the airbag cushion 112 in an uninflated state before the airbag assembly 110 is deployed. The airbag cushion 112 may be rolled as shown when the airbag cushion 112 is contained within the housing 58. When the airbag cushion 112 is deployed, the airbag cushion 112 may unroll in the lateral (side-to-side) direction of a vehicle over the legs of an occupant or objects on the floor of the vehicle. An airbag cushion according to the present disclosure may rolled, folded in an accordion manner, subjected to a combination of rolling and accordion-style folding, or tucked inside itself before being stored inside the housing 58.

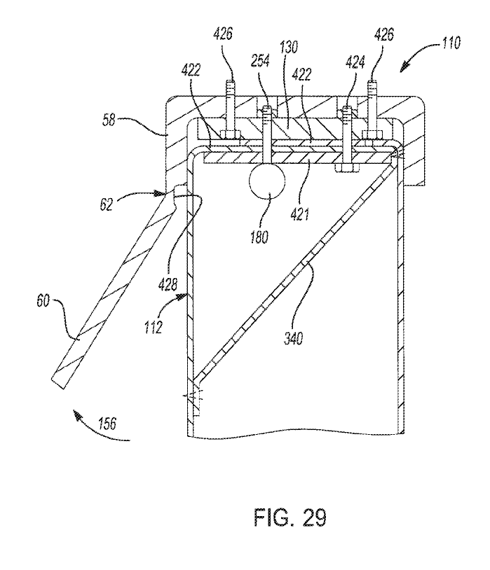

Referring now to FIG. 29, another example implementation of the airbag assembly 110 is shown that includes the tether 340 which prevents the airbag cushion 112 from rotating in the direction 156. In addition, the inflator 180 is located within the airbag cushion 112. Further, the airbag cushion 112 includes overlapping flaps 422, and one or more bolts 424 extend through a cushion plate 421 and the mounting plate 130 to secure the airbag cushion 112 to the mounting plate 130. The threaded rod 254 on the inflator 180 also extends through the cushion plate 421 and the mounting plate 130 to secure the airbag cushion 112 to the mounting plate 130. Further, the airbag assembly 110 includes a pair of bolts 426 that pass through the mounting plate 130 and the housing 58 and attach the housing 58 to a side wall of a vehicle, and a notch 428 is present between the housing 58 and the door 60 to provide a living hinge that serves as the hinge 64.

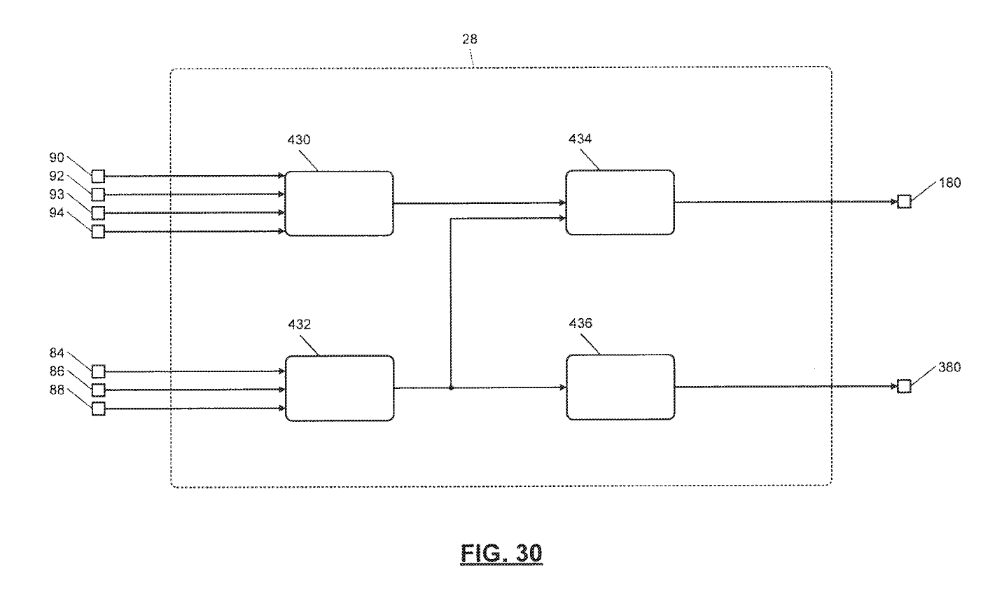

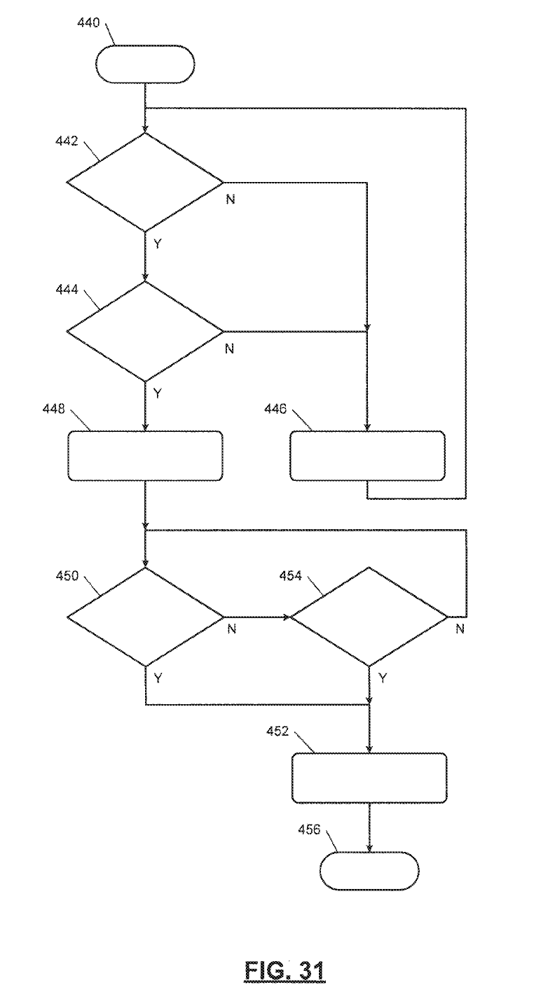

Referring now to FIG. 30, an example implementation of the airbag control module 28 of FIG. 1 is shown. The airbag control module 28 includes an occupant detection module 430, an impact magnitude module 432, an inflator control module 434, and a vent control module 436. The occupant detection module 430 determines whether occupants are present in the first and second seats 14 and 16 based on an input from an occupant detection device such as the weight sensor 90, the capacitive sensor 92, the pressure sensor 93, and/or the camera 94.

In one example, the occupant detection module 430 determines that an occupant is present in the first seat 14 when the weight measured by the weight sensor 90 is greater than a predetermined weight. In another example, the occupant detection module 430 determines that an occupant is present in the second seat 16 when the capacitance measured by the capacitive sensor 92 is greater than a predetermined capacitance. In another example, the occupant detection module 430 determines that an occupant is present in the second seat 16 when the pressure measured by the pressure sensor 93 is greater than a predetermined pressure. In another example, the occupant detection module 430 determines that an occupant is present in the first or second seat 14 or 16 when the image obtained by the camera 94 indicates that an occupant is present in the first or second seat 14 or 16.

The impact magnitude module 432 determines a magnitude of an impact in which the vehicle 10 is involved based on an input from the accelerometer(s) 84, the pressure sensor(s) 86, and/or the gyroscope(s) 88. In one example, the impact magnitude module 432 determines the impact magnitude based on a directly proportional relationship between the acceleration measured by the accelerometer 84 and the impact magnitude. In another example, the impact magnitude module 432 determines the impact magnitude based on a directly proportional relationship between the pressure measured by the pressure sensor 86 and the impact magnitude. In another example, the impact magnitude module 432 determines the impact magnitude based on a directly proportional relationship between the angular velocity measured by the gyroscope 88 and the impact magnitude.

The inflator control module 434 may control the inflator 180 in each of the first and second airbag assemblies 24 and 26 to deploy the airbag cushion 64 therein when the vehicle 10 is involved in an impact or collision such as an impact to a portion of the vehicle 10 in front of the first and second occupants 40 and 44 or an impact that causes the vehicle 10 to rollover. In one example, the inflator control module 434 controls the inflator 180 in the first airbag assembly 24 to deploy the airbag cushion 64 therein when an occupant is present in the first seat 14 and the impact magnitude is greater than a predetermined value. In another example, the inflator control module 434 controls the inflator 180 in the second airbag assembly 26 to deploy the airbag cushion 64 therein when an occupant is present in the second seat 16 and the impact magnitude is greater than the predetermined value.

The vent control module 436 opens the pyrotechnic vent 380 to deflate the airbag cushion 64 in each of the first and second airbag assemblies 24 and 26 after the vehicle 10 is involved in an impact. In one example, the vent control module 436 opens the pyrotechnic vent 380 when a predetermined amount of time (e.g., 5 seconds) has elapsed after the vehicle 10 is involved in an impact (e.g., after the impact magnitude is initially greater than the predetermined value). In another example, the vent control module 436 opens the pyrotechnic vent 380 when the first door 20 is opened after an impact. In another example, the vent control module 436 opens the pyrotechnic vent 380 when the second door 22 is opened after an impact. The vent control module 436 may determine or be informed when the first and second doors 20 and 22 are opened based on a commanded door position and/or an input from a door latch engagement sensor (not shown).

Referring now to FIG. 31, an example method of controlling an airbag assembly according to the present disclosure starts at 440. The method is described in the context of the modules of FIG. 30. However, the particular modules that perform the steps of the method may be different than the modules mentioned below, or the method may be implemented apart from the modules of FIG. 30.

At 442, the occupant detection module 430 determines whether an occupant is present in the first seat 14 of the vehicle 10 of FIG. 1. If an occupant is present in the first seat 14, the method continues at 444. Otherwise, the method continues at 446. At 446, the inflator control module 434 does not control the inflator 180 to deploy the airbag cushion 64 in the first airbag assembly 24.

At 444, the impact magnitude module 432 determines whether the vehicle 10 is involved in an impact have a magnitude greater than a first threshold (e.g., a predetermined value). If the vehicle 10 is involved in an impact having a magnitude greater than the first threshold, the method continues at 448. Otherwise, the method continues at 446. At 448, the inflator control module 434 controls the inflator 180 to deploy the airbag cushion 64 in the first airbag assembly 24.

At 450, the vent control module 436 determines whether the period elapsed since the impact is greater than a second threshold (e.g., a predetermined period). The vent control module 436 may start measuring this period when the impact magnitude is initially greater than the first threshold. If the elapsed period is greater than the second threshold, the method continues at 452. Otherwise, the method continues at 454.

At 454, the vent control module 436 determines whether the first door 20 is open. If the first door 20 is open, the method continues at 452. Otherwise, the method continues at 450. At 452, the vent control module 436 opens the vent 180. The method ends at 456.

The method of FIG. 31 may include additional steps if the deployed airbag cushion limits the upward motion of the legs of more than one occupant of the vehicle 10. In this case, at 442, the occupant detection module 430 determines whether an occupant is present in any seating position that the deployed airbag cushion covers. The method of FIG. 31 may also be expanded to use different thresholds for different types of impacts. For example, at 444, the impact magnitude module 432 may determine whether the vehicle 10 is involved in a frontal impact having a magnitude greater than a first threshold or a rollover event having a rollover magnitude that is greater than the first magnitude. In addition, the method of FIG. 31 may be modified by including only one of the steps 450 and 454 and omitting the other one of the steps 450 and 454. If step 450 is omitted, the method may continue at 454 directly from 448. If step 454 is omitted, the method may remain at 450 until the elapsed period is greater than the second threshold.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “front,” “forward,” “rear,” “rearward,” “inner,” “outer,” “behind,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. An airbag assembly comprising:
an elongated cushion configured to deploy from an interior side wall of a vehicle into a passenger compartment of the vehicle to resist upward motion of a leg of an occupant of the vehicle; and
a restraint configured to prevent the elongated cushion from rotating upward and toward the side wall when the leg of the occupant contacts an underside surface of the elongated cushion.

2. The airbag assembly of claim 1 wherein the restraint includes a tether configured to wrap around a top surface of the elongated cushion when the elongated cushion is deployed and having opposite ends configured to be fixed relative to the side wall.

3. The airbag assembly of claim 2 further comprising a mounting plate to which the elongated cushion is attached, wherein the opposite ends of the tether are fixed to the mounting plate.

4. The airbag assembly of claim 2 wherein the opposite ends of the tether are configured to be fixed directly to the side wall of the vehicle.

5. The airbag assembly of claim 2 wherein the tether is attached to at least one of the top surface of the elongated cushion, a bottom surface of the elongated cushion, and a side surface of the elongated cushion.

6. The airbag assembly of claim 1 further comprising:
a housing configured to be disposed within and attached to the side wall and to contain the elongated cushion before the elongated cushion is deployed; and
a door configured to conceal the elongated cushion from view when the elongated cushion is contained within the housing.

7. The airbag assembly of claim 6 further comprising a hinge attaching the door to the housing and allowing the door to pivot when the elongated cushion is deployed, wherein the restraint includes:
the door; and
at least one tether that has a first end configured to be fixed relative to the side wall and a second end opposite of the first end and attached to the door to limit an amount by which the door pivots upwards when the elongated cushion is deployed.

8. The airbag assembly of claim 1 wherein the restraint includes at least one tether disposed within the elongated cushion and having a first end configured to be fixed relative to the side wall and a second end opposite of the first end and attached to an upper inner surface of the elongated cushion.

9. The airbag assembly of claim 1 wherein:
the elongated cushion has a first end configured to be fixed relative to the side wall and a second end opposite of the first end; and
the restraint includes an inflated foot disposed adjacent to the first end of the elongated cushion and projecting from a top surface of the elongated cushion.

10. The airbag assembly of claim 1 wherein the elongated cushion includes at least one tubular chamber having a longitudinal axis extending in a lateral direction of the vehicle.

11. The airbag assembly of claim 10 wherein the at least one tubular chamber includes multiple tubular chambers in fluid communication with one another.

12. The airbag assembly of claim 11 further comprising multiple tethers disposed within the elongated cushion and defining a boundary between the tubular chambers.

13. The airbag assembly of claim 11 further comprising at least one seam joining portions of the elongated cushion to one another and defining a boundary between the tubular chambers.

14. An airbag system comprising:
a first elongated cushion configured to deploy from one of a first interior side wall of a vehicle and a center structure of the vehicle into a passenger compartment of the vehicle, the first elongated cushion having a first end mounted to the one of the first interior side wall and the center structure and a second end opposite of the first end; and
an interlocking device configured to interlock with the second end of the first elongated cushion to prevent the first elongated cushion from moving out of a path of a leg of an occupant of the vehicle when the leg contacts the first elongated cushion.

15. The airbag system of claim 14 wherein the interlocking device includes the other one of the first interior side wall and the center structure.

16. The airbag system of claim 14 wherein the interlocking device includes a second elongated cushion configured to deploy from a second interior side wall of the vehicle that is opposite of the first interior side wall.

17. A control system comprising:
an inflator control module configured to control an inflator to deploy an airbag cushion from an interior side wall of a vehicle into a space disposed in front of a seat of the vehicle relative to a direction in which the seat is facing; and
a vent control module configured to control a vent to deflate the airbag cushion after the airbag cushion is deployed.

18. The control system of claim 17 wherein the inflator control module is configured to control the inflator to deploy the airbag cushion when an occupant is present in the seat and the vehicle is involved in an impact having a magnitude that is greater than a predetermined value.

19. The control system of claim 17 wherein the vent control module is configured to open the vent when a predetermined amount of time has elapsed after the vehicle is involved in an impact.

20. The control system of claim 17 wherein:
the airbag cushion is mounted to a door of the vehicle;
the interior side wall is part of the door; and
the vent control module is configured to open the vent when the door is opened after the vehicle is involved in an impact.
